(19) United States
(12) Patent Application Publication
(10) Pub. No.: US 2008/0156189 A1
(43) Pub. Date: Jul. 3, 2008

(54) COMPOSITIONS FOR CARBON MONOXIDE AND OLEFIN ADSORPTION

(75) Inventors: Oleg Gennadyevich Polyakov, Fort Collins, CO (US); Steven Howard Strauss, Fort Collins, CO (US); Igor Vladimirovich Kuvychko, Fort Collins, CO (US)

Correspondence Address: MARSH, FISCHMANN & BREYFOGLE LLP, 3151 SOUTH VAUGHN WAY, SUITE 411, AURORA, CO, 80014, US

(73) Assignee: SYNKERA TECHNOLOGIES, INC., Longmont, CO (US)

(21) Appl. No.: 11/746,487

(22) Filed: May 9, 2007

Related U.S. Application Data
(60) Provisional application No. 60/767,518, filed on May 9, 2006.

(51) Int. Cl. B01D 53/14; B32B 9/04; C07F 1/08; B32B 15/04

(52) U.S. Cl. 95/90; 428/457; 428/469; 96/108; 556/111; 548/402; 548/103; 546/4; 544/225

(57) ABSTRACT

A solid-state composition having the general formula CuₓAₙL_{y}Z, where: A is CO or an olefin and n=0 or n>0; L is an electrically neutral ligand and O<y<0; and Z is an anion bearing a charge x-. The solid-state composition can advantageously adsorb CO or an olefin in the presence of water. The neutral ligand L can be selected from the electrically neutral hydrophobic ligands having: a) one or more aryl or substituted aryl groups of a general formula of C₆Rₖ, where k≦5; b) one or more pyrrolyl or substituted pyrrolyl groups of a general formula of C₄NRₖ, where k≦4; c) one or more pyrazolyl or substituted pyrazolyl groups of a general formula of C₃N₂Rₖ, where k≦3; d) one or more pyridinyl or substituted pyridinyl groups of a general formula of C₅NRₖ, where k≦4; e) one or more pyridazinyl or substituted pyridazinyl groups of a general formula of C₄N₂Rₖ, where k≦3; f) one or more pyrimidyl or substituted pyrimidyl groups of a general formula of C₄N₂Rₖ, where k≦3; or g) one or more pyrazinyl or substituted pyrazinyl groups of a general formula of C₄N₂Rₖ, where k≦3, and R is hydrogen, alkyl, nitrile, or aryl. The present invention is also directed to an apparatus incorporating the composition, and to a method for adsorbing CO or olefins from a fluid mixture including water using the composition.

### CROSS-REFERENCE TO RELATED APPLICATIONS

This application claims priority to U.S. Provisional Patent Application Ser. No. 60/767,518, filed on May 9, 2006, which is incorporated herein by reference in its entirety.

### STATEMENT REGARDING FEDERALLY-FUNDED RESEARCH

This invention was funded by the U.S. Department of Defense, Department of the Army, under Contracts Nos. W911NF-04-C-0088 and W911NF-05-C-0121, as administered by the Small Business Technology Transfer (STTR) program. The Government has certain rights in this invention.

### BACKGROUND OF THE INVENTION

1. Field of the Invention

The present invention relates to copper-based adsorbent compositions that are adapted to adsorb carbon monoxide (CO) and/or olefins (i.e., alkenes). The compositions are particularly useful for adsorbing CO or olefins in the presence of water. The adsorbents can be used, for example, to absorb CO from a hydrogen-containing gas stream, such as for delivery to a proton exchange membrane (PEM) fuel cell where CO can poison the electrocatalysts.

2. Description of Related Art

Fuel processors convert hydrogen-containing compounds such as methanol into a gas stream that is predominately hydrogen (H₂). The main obstacle that impedes the use of fuel processors for delivery of H₂ to PEM fuel cells is the unacceptably high level of carbon monoxide (CO) in the hydrogen gas stream that is generated. For example, the CO content in an H₂ gas stream from catalytic methanol steam reformation is typically about 1% to 2%, and it must be reduced to 1 ppm to 5 ppm or lower before the H₂ gas stream can be fed into the fuel cell. Several methods exist to purify the H₂ gas stream by removing CO, including separation by selective membranes, selective catalytic oxidation of CO, catalytic methanation and selective adsorption. However, it is believed that none of the methods can be used to decrease the CO content to 1 ppm or below, particularly with a processor weight and size low enough for portable applications.

H₂ separation using membranes is a large-scale, high-temperature, and high-pressure process that has not been adapted for portable devices. Catalytic conversion (i.e., the selective oxidation or methanation of CO) cannot provide an H₂ gas stream with a sufficiently low residual CO content with low processor weight and size.

Conventional adsorption technology as currently practiced by suppliers of bulk purified CO, although relatively simple, inexpensive, and essentially quantitative, is difficult to reduce to a portable scale. Furthermore, conventional CO adsorbents decompose slowly upon exposure to water vapor and therefore are unsuitable for use in conjunction with fuel processors.

A unique combination of physical and chemical properties make Cu(I) (i.e., Cu⁺) the preferred metal-ion for rapid and reversible CO adsorption, and Cu(I)-containing materials are used almost exclusively for the selective adsorption of CO, such as by pressure- or vacuum-swing adsorption. Copper is unique in that it is the only first-row transition metal with a stable 1+ oxidation state in simple salts (e.g., CuCI, Cul, CuAICI₄, CuAsF₆). Other metals from Sc to Zn form 2+, 3+, and 4+ ions that have too high a charge, cannot participate in π-backbonding with CO, and hence do not bind CO at ambient temperatures and low pressure. The Cu⁺ ion, on the other hand, exhibits a modest amount of π-backbonding, forming reasonably strong but reversible complexes with CO. Being in the first row of the transition series, Cu is significantly lighter in weight than second- and third-row transition metal ions that can bind CO, such as Rh⁺, Ir⁺, Pd²⁺, and Pt²⁺. Furthermore, these latter four metal ions do not bind CO reversibly, and Cu is more abundant and far less expensive than Rh, Ir, Pd or Pt.

Several polycarbonyls of zerovalent state metals with irreversibly bonded CO are known, such as Cr(CO)₆, Fe(CO)₅, Ni(CO)₄, in which the CO molecules are very strongly bound. However, the exotic conditions required for their formation (e.g., 150° C. and a CO pressure of 100 atm for Fe(CO)₅) as well as their volatility and toxicity make it difficult to create practical CO adsorbents based on finely dispersed Cr, Fe, or Ni metals.

Commercially available CO adsorbents are typically based on finely dispersed CuCI. However, the extremely low specific capacity of CuCI precludes its use in portable applications. The problem is the intrinsically low affinity of solid CuCI for gaseous CO, even at 0.5 atm pressure, which is due to the strong coordination of the Cl⁻ anions to Cu(I).

To be suitable for use in portable lightweight fuel processors, such as for PEM fuel cells, an adsorbent must be able to efficiently bind CO in the presence of water. Water is needed in the hydrogen gas stream fed to PEM fuel cells to maintain proton conductivity in the proton exchange membrane. However, water molecules compete with CO for Cu(I) coordination sites and therefore diminish CO uptake. To reach the desired ≦1 ppm level of CO content in purified wet hydrogen, an unacceptably large mass of CuCI-based adsorbent would be required.

In addition, CuCI adsorbents suffer from long-term chemical instability in the presence of water. One problem is that corrosive and toxic hydrogen chloride (HCl) gas is formed over time. An even more significant problem is that water can cause the disproportionation of Cu(I) to a mixture of Cu(II) and Cu(0) metal, neither of which stoichiometrically bind CO.

U.S. Pat. No. 6,114,266 by Strauss et al. discloses copper complexes for CO and olefin adsorption. The complexes have the general formula Cu(A)ₙZ, where A is CO or an olefin, n>1 and Z is a unitary or composite monovalent anion. It is disclosed that the complexes can adsorb CO or olefins in molar ratios (e.g., CO:Cu) greater than one. However, these complexes are moisture-sensitive, as indicated by the disclosure of Strauss et al. that the physical measurements were carried out with the rigorous exclusion of water. Thus, these complexes are not capable of adsorbing appreciable quantities of CO or olefins in the presence of water, as may be required in applications such as PEM fuel cells.

There remains a need for a material that is capable of adsorbing CO and/or olefins in the presence of water, such as for the purification of gas streams that are delivered to a PEM fuel cell.

### SUMMARY OF THE INVENTION

It is an object of the present invention to provide a solid-state adsorbent composition that is adapted to adsorb CO or an olefin in the presence of H₂O.

According to one aspect, a composition is provided having the formula CuₓAₙL_{y}Z, where: A is CO or an olefin and n=0 or n>0; L is an electrically neutral hydrophobic ligand and y>0; and Z is an anion bearing charge x-.

According to another aspect, the adsorption characteristics of the composition can be modified by changing the coordinating anion (Z) and/or by changing the ligand (L). The selection of a stronger or weaker coordinating anion, which defines the coordination environment of the Cu(I) ion, advantageously permits modification of the CO adsorption rate and capacity. Proper selection of the ligand can modify the hydrophobicity of the Cu(I) environment and can advantageously permit the adsorption CO in the presence of water.

Thus, the compositions of the present invention have the ability to adsorb CO or an olefin while inhibiting the disproportionation of Cu(I) into Cu(0) and Cu(II) in the presence of water. The compositions of the present invention can reversibly bind CO even at levels of 1 ppm or less.

### DESCRIPTION OF THE DRAWINGS

FIG. 1 illustrates the calculated CO adsorption isotherms at 25° C. for CuCI, CuCF₃COO and CuCF₃SO₃ finely dispersed on an inert high-surface area support.

FIGS. 2(a) and 2(b) illustrate experimental CO-adsorption isotherms at 25° C. for two samples of bulk Cu[CHPh₃]N(SO₂CF₃)₂.

FIG. 3 illustrates a comparison of the experimental kinetics of CO adsorption by bulk Cu[CHPh₃]N(SO₂CF₃)₂ and by Cu[CHPh₃]N(SO₂CF₃)₂ dispersed on an inert high-surface area support under various conditions.

### DESCRIPTION OF THE INVENTION

The present invention is directed to solid-state Cu(I) compositions that are adapted to adsorb CO or an olefin (i.e., alkenes), and in particular that are adapted to adsorb CO or olefins in the presence of water vapor.

The adsorbent compositions of the present invention have the general formula CuₓAₙL_{y}Z, where: A is an adsorbate selected from CO or an olefin, and n=0 or n>0; L is an electrically neutral hydrophobic ligand and y>0; and Z is a coordinating anion that bears a charge x-.

The adsorbent Cu(I) compositions of the present invention are capable of existing in a state where n>0—that is, where adsorbates such as carbonyls or olefins are adsorbed by the composition. In one embodiment, the value of n is greater than 1, such that the composition can adsorb CO or olefins relative to CO in molar ratios (i.e., CO:Cu) greater than one.

The ligand (L) can be selected to provide a hydrophobic environment for the composition, thereby enabling the composition to be utilized in the presence of water, such as where water is a component of the gas stream that contacts the adsorbent. The ligand can be selected from electrically neutral ligands, and preferably can comprise one or more of aryl or substituted aryl groups, pyrrolyl or substituted pyrrolyl groups, pyrazolyl or substituted pyrazolyl groups, pyridinyl or substituted pyridinyl groups, pyridazinyl or substituted pyridazinyl groups, pyrimidyl or substituted pyrimidyl groups and pyrazinyl or substituted pyrazinyl groups. The composition can include one or more of the foregoing groups or combinations of groups.

Aryl or substituted aryl groups can have the general formula C₆Rₖ, where k≦5 and R can be selected from hydrogen, an alkyl, a nitrile, or another aryl. The aryl or substituted aryl group will constitute a fragment of the neutral ligand by being chemically bonded to the rest of the ligand through a bond connecting one or more carbons from the group to hydrogen, halogen, carbon, boron, nitrogen, oxygen, silicon, phosphorus, sulfur, or a metal belonging to the rest of the ligand. Examples of these ligands include, but are not limited to, benzene, biphenyl, toluene, diphenylmethane, triphenylmethane, hexaphenylbenzene, trimesitylborane, benzonitrile, styrene, olygostyrene, polystyrene, naphthalene, anthracene, dibenzosuberane and pyrene.

Pyrrolyl or substituted pyrrolyl groups can have the general formula of C₄NRₖ, where k≦4 and R is selected from hydrogen, an alkyl, a nitrile, or an aryl. The pyrrolyl or substituted pyrrolyl group will constitute a fragment of the neutral ligand by being chemically bonded to the rest of the ligand through a bond connecting one or more carbons from the group to hydrogen, halogen, carbon, boron, nitrogen, oxygen, silicon, phosphorus, sulfur, or a metal belonging to the rest of the ligand. Examples of these ligands include, but not limited to, pyrrol, 2-methylpyrrole, N-methylpyrrole, and 3-(pyrrol-1-ylmethyl)pyridine.

Pyrazolyl or substituted pyrazolyl groups can have the general formula of C₃N₂Rₖ, where k≦3 and R can be selected from hydrogen, an alkyl, a nitrile, or an aryl. The pyrazolyl or substituted pyrazolyl group will constitute a fragment of the neutral ligand by being chemically bonded to the rest of the ligand through a bond connecting one or more carbons from the group to hydrogen, halogen, carbon, boron, nitrogen, oxygen, silicon, phosphorus, sulfur, or a metal belonging to the rest of the ligand. Examples of these ligands include, but not limited to, pyrazole, 3-methylpyrazole, pyrazole-72.

Pyridinyl or substituted pyridinyl groups can have the general formula of C₅NRₖ, where k≦4 and R can be selected from hydrogen, an alkyl, a nitrile, or an aryl. The pyridinyl or substituted pyridinyl group will constitute a fragment of the neutral ligand by being chemically bonded to the rest of the ligand through a bond connecting one or more carbons from the group to hydrogen, halogen, carbon, boron, nitrogen, oxygen, silicon, phosphorus, sulfur, or a metal belonging to the rest of the ligand. Examples of these ligands include, but not limited to, pyridine, 2-pyridinecarbonitrile, 2,4-pyridinedicarbonitrile, 3-pyridineboronic acid and 1,3-propanediol ester.

Pyridazinyl or substituted pyridazinyl groups can have the general formula of C₄N₂Rₖ, where k≦3 and R can be selected from hydrogen, an alkyl, a nitrile, or an aryl. The pyridazinyl or substituted pyridazinyl group will constitute a fragment of the neutral ligand by being chemically bonded to the rest of the ligand through a bond connecting one or more carbons from the group to hydrogen, halogen, carbon, boron, nitrogen, oxygen, silicon, phosphorus, sulfur, or a metal belonging to the rest of the ligand. Examples of these ligands include, but not limited to, pyridazine, 3-methylpyridazine, and 4-cyanopyridazine.

Pyrimidyl or substituted pyrimidyl groups can have a general formula of C₄N₂Rₖ, where k≦3 and R can be selected from hydrogen, an alkyl, a nitrile, or an aryl. The pyrimidyl or substituted pyrimidyl group will constitute a fragment of the neutral ligand by being chemically bonded to the rest of the ligand through a bond connecting one or more carbons from the group to hydrogen, halogen, carbon, boron, nitrogen, oxygen, silicon, phosphorus, sulfur, or a metal belonging to the rest of the ligand. Examples of these ligands include, but not limited to, pyrimidine, 2-pyrimidinecarbonitrile, and 1-(2-pyrimidyl)piperazine.

Pyrazinyl or substituted pyrazinyl groups can have a general formula of C₄N₂Rₖ, where k≦3 and R can be selected from hydrogen, an alkyl, a nitrile, or an aryl. The pyrazinyl or substituted pyrazinyl group will constitute a fragment of the neutral ligand by being chemically bonded to the rest of the ligand through a bond connecting one ore more carbons from the group to hydrogen, halogen, carbon, boron, nitrogen, oxygen, silicon, phosphorus, sulfur, or a metal belonging to the rest of the ligand. Examples of these ligands include, but not limited to, pyrazine, pyrazinecarbonitrile, 2,3-pyrazinedicarbonitrile, and methylpyrazine.

The value y in the adsorbent composition represents the number of ligands that are incorporated into the composition, and y is greater than 0. According to one embodiment, y is not greater than 4. In this regard, increasing the value of y can enhance the hydrophobicity of the Cu(I) environment and increase the selective coordination of CO or olefin to Cu(I), as opposed to water. However, increasing the value of y also can decrease the total adsorption capacity. Therefore, the value of y can be varied to adjust the adsorbent hydrophobicity and hence chemical stability and service lifetime of the adsorbent for adsorption from gas streams containing water, but this should be balanced against the total absorption capacity needs for the composition.

The coordinating anion (Z) is preferably an anion that is chemically stable in liquid water or water vapor. Suitable anions can include, but are not limited to, weakly coordinating anions such as:

1) RSO₃⁻, such as where:
R can be selected from alkyl, fluoroalkyl, perfluoroalkyl, aryl, fluoroaryl or perfluoroaryl;

2) N(SO₂RᵢR′ⱼ)⁻, such as where:
R can be selected from alkyl, fluoroalkyl, perfluoroalkyl, aryl, fluoroaryl or perfluoroaryl;
R′ can be selected from alkyl, fluoroalkyl, perfluoroalkyl, aryl, fluoroaryl or perfluoroaryl; and
i+j=2 and i=1 or 2;

3) C(SO₂RᵢR′ⱼ)⁻, such as where:
R can be selected from alkyl, fluoroalkyl, perfluoroalkyl, aryl, fluoroaryl or perfluoroaryl;
R′ can be selected from hydrogen, alkyl, fluoroalkyl, perfluoroalkyl, aryl, fluoroaryl or perfluoroaryl; and
i+j=3 and i=1, 2 or 3;

4) CB₁₁H₁₂₋ₘXₘ⁻, such as where:
m is from 0 to 12; and
X is selected from the group consisting of halogen, alkyl, fluoroalkyl, perfluoroalkyl, aryl, fluoroaryl or perfluoroaryl;

5) CB₉H₁₀₋ₘXₘ⁻, such as where:
m is from 0 to 10; and
X is selected from the group consisting of halogen, alkyl, fluoroalkyl, perfluoroalkyl, aryl, fluoroaryl or perfluoroaryl;

6) CB₁₁F₁₁R⁻, such as where:
R is alkyl, fluoroalkyl, perfluoroalkyl, aryl, fluoroaryl or perfluoroaryl or ammonium;

7) B₁₂H₁₂₋ₘXₘ²⁻, such as where:
m is from 0 to 12; and
X is at least one member selected from the group consisting of halogen, alkyl, fluoroalkyl, perfluoroalkyl, aryl, fluoroaryl or perfluoroaryl;

8) RCOO⁻ where R is selected from the group consisting of alkyl, fluoroalkyl, perfluoroalkyl, aryl, fluoroaryl or perfluoroaryl; and/or

9) common anions, such as Cl⁻, Br⁻, SO₄²⁻, HSO₄⁻, NO₃⁻, PO₄³⁻, HPO₄²⁻ and H₂PO₄⁻.

The compositions of the present invention can be utilized as a bulk solid, or can be dispersed upon and supported by a solid substrate. Suitable solid substrates can include activated carbon, zeolites, alumina, silica, aerogels, polystyrene, copolymers of styrene and other monomers, or other organic polymers. For example, the composition can be provided on a solid substrate in accordance with the teachings of U.S. Pat. No. 4,917,711 by Xie et al., which is incorporated herein by reference in its entirety.

The present invention is also directed to an apparatus that is adapted to adsorb an adsorbate A from a fluid mixture, such as a mixture of gases. The apparatus comprises an adsorbent composition as described hereinabove having the formula CuₓAₙL_{y}Z. The adsorbent composition can be in bulk form or can be dispersed upon a supporting substrate.

Preferably, the apparatus is a gas adsorption apparatus adapted to adsorb gaseous CO from a gaseous mixture by contacting a gaseous mixture comprising CO and/or olefins with the adsorbent composition. Apparatus that can be useful in this regard include those disclosed in U.S. Pat. No. 5,300,271 by Golden et al., U.S. Pat. No. 5,258,571 by Golden et al. and U.S. Pat. No. 3,944,440 by Franz. Each of the foregoing U.S. Patents is incorporated herein by reference in its entirety.

According to another embodiment of the present invention, a method for adsorbing an adsorbate from a fluid mixture is provided. The method can include contacting a fluid mixture with the adsorbent composition and adsorbing the adsorbate, wherein the adsorbent composition adsorbs the adsorbate in the presence of water vapor. In one embodiment, the fluid mixture comprises gaseous CO or an olefin, and also comprises H₂O in an amount of at least about 0.01 vol. %, such as at least about 0.1 vol. %, at least about 1 vol. %, or even at least about 3 vol. % or higher. For example, the amount of H₂O can be up to about 6 vol. % or even higher. In one embodiment, the fluid mixture is the reaction product of a fuel processor processing a hydrocarbon fuel to H₂ for conveyance to a fuel cell, where the fluid mixture comprises H₂, CO and H₂O, such as from about 0.01 vol. % to about 6 vol. % H₂O. It is an advantage of the present invention that the adsorbent composition can adsorb appreciable quantities of CO or olefins in the presence of H₂O without substantial degradation of the composition due to the presence of H₂O.

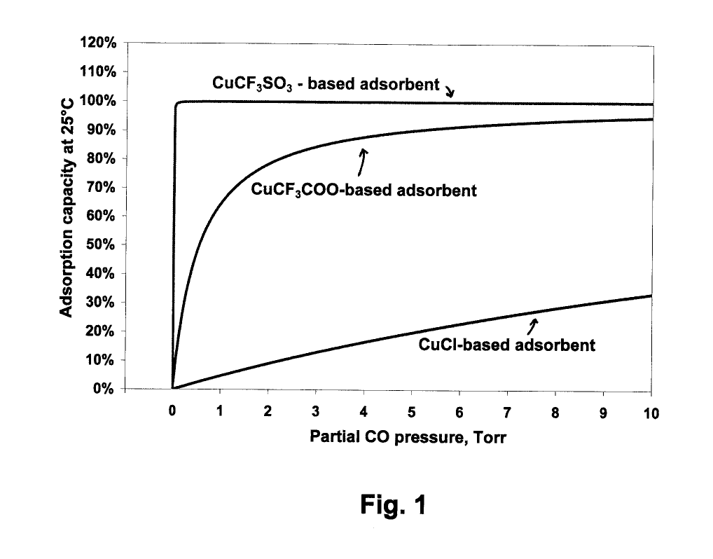

The capacity to adsorb an adsorbate such as CO is influenced by the coordinating anion (Z). Specifically, the use of weaker coordinating anions will lead to higher adsorption capacities. As an example, FIG. 1 illustrates the adsorption capacity for compositions comprising three different coordinating anions. As is illustrated in FIG. 1, the use of a trifluoromethanesulfonate anion that is weaker than a trifluoroacetate anion that, in turn, is weaker than a chloride anion, increases the adsorption capacity and uptake of CO at a low partial pressure of CO.

The use of stronger coordinating anions, for example chloride or sulfate anions, in comparison to weakly coordinating anions such as trifluoromethanesulfonate, can decrease the affinity of CO or olefin to Cu(I). This, however, can facilitate the reversible adsorption of CO or olefin for use in applications such as pressure-swing or vacuum-swing adsorption. Swing adsorption methods can be used for efficiently concentrating CO or olefin from gas streams and producing purified CO or olefins.

Gas stream purification, such as in portable fuel processors, require a strong affinity of CO or olefin to Cu(I) and therefore the use of weakly coordinating anions is advantageous.

Further, the use of strongly coordinating ligands, such as benzonitrile and acetonitrile, in comparison to more weakly coordinating ligands such as triphenylmethane, can enable adsorption of CO or olefin from gas streams with a higher content of water vapor. As the use of stronger coordinating ligands is typically accompanied by a decrease the adsorption capacity, use of weakly coordinating ligand, e.g., triphenylmethane, is preferred for adsorption from gas streams with a lower content of water vapor.

The present invention will be illustrated in more detail with reference to the following Examples, but it should be understood that the present invention is not deemed to be limited thereto.

### EXAMPLES

### Example 1

### Synthesis and Characterization of Cu[CHPh₃]N(SO₂CF₃)₂

Cu[CHPh₃]N(SO₂CF₃)₂ is synthesized by reacting stoichiometric amounts of mesityl-copper(I), trifluoromethanesulfonimide, and triphenylmethane in dichloromethane, followed by evaporation of the solvent and mesitylene under a vacuum. To obtain an alumina-supported adsorbent, a dry high-surface alumina is soaked in a dichloromethane or toluene solution of Cu[CHPh₃]N(SO₂CF₃)₂ followed by evaporation of the solvent under a vacuum.

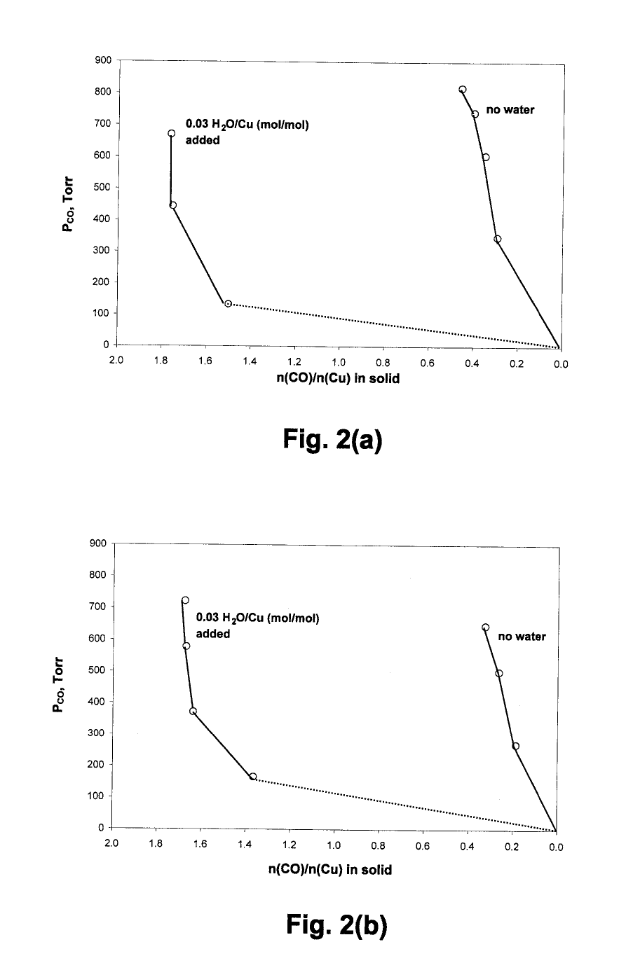

The measurement of CO adsorption by bulk Cu[CHPh₃]N(SO₂CF₃)₂ results in an unexpected discovery: the presence of water in the system enhances both the CO adsorption capacity and the CO adsorption kinetics, as compared to the uptake of pure CO. This accelerating effect is illustrated for two samples in FIGS. 2(a) and 2(b).

Under an atmosphere of pure CO, the molar ratio of CO/Cu(I) in the solid phase does not increase above 0.5, even after a long exposure time (e.g., 70 hours-170 hours) and up to 850 Torr CO, as is illustrated in FIG. 2(a) and FIG. 2(b). However, after the addition of small amount of water to the gas composition (H₂O/Cu(I)=0.03 mol/mol), in a relatively short time (16-20 hours) the content of adsorbed CO increases from a range of 0.35-0.5 to a range of 1.4-1.5 CO molecules per Cu(I). Afterwards, further addition of CO results in fast CO uptake (1-4 hours for each point of CO addition) until the CO/Cu(I) ratio reaches the value of 1.70-1.75 and does not increase at higher CO pressures.

Kinetic data on CO adsorption are taken during the first addition of CO to the fresh adsorbents. In the experiments with a constant pressure of water vapor, adsorbents are exposed to water for 24 hours prior to CO exposure.

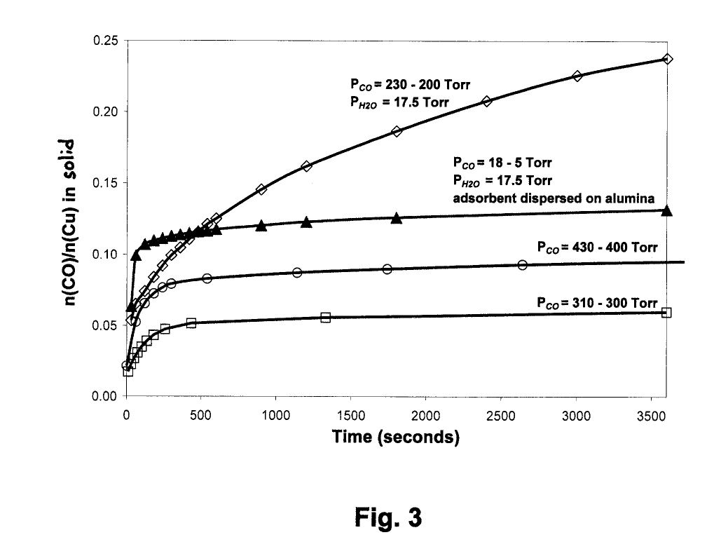

The kinetic curves illustrated in FIG. 3 confirm the favorable effect of water on the rate and capacity of CO adsorption. The ranges of CO pressure indicate how much CO pressure changed during the kinetic measurement over a period of 1 hour. For the bulk Cu[CHPh₃]N(SO₂CF₃)₂ (illustrated by the open circles, squares and rhombs), an increase of initial CO pressure in the absence of water increases the rate and amount of CO uptake. With water present, both the rate and capacity of adsorption by bulk Cu[CHPh₃]N(SO₂CF₃)₂ increase significantly even at smaller values of CO pressure.

The alumina-supported adsorbent (curve marked with solid triangles) exhibits a high rate and capacity of CO uptake at CO pressures even lower than the pressure of water vapor.

While various embodiments of the present invention have been described in detail, it is apparent that modifications and adaptations of those embodiments will occur to those skilled in the art. However, it is to be expressly understood that such modifications and adaptations are within the spirit and scope of the present invention.

What is Claimed is:

1. A solid-state composition having the formula CuₓAₙL_{y}Z, where:
A is CO or an olefin and n=0 or n>0;
L is an electrically neutral ligand and 0<y<4; and
Z is an anion having charge x-.

2. A composition as recited in claim 1, where said ligand comprises one or more chemical groups selected from the group consisting of aryl or substituted aryl groups, pyrrolyl or substituted pyrrolyl groups, pyrazolyl or substituted pyrazolyl groups, pyridinyl or substituted pyridinyl groups, pyridazinyl or substituted pyridazinyl groups, pyrimidyl or substituted pyrimidyl groups and pyrazinyl or substituted pyrazinyl groups or combinations thereof.

3. A composition as recited in claim 2, wherein said ligand comprises an aryl or substituted aryl group having the general formula of C₆Rₖ, where k≦5 and R is selected from the group consisting of hydrogen, alkyl, nitrile and aryl.

4. A composition as recited in claim 2, wherein said ligand comprises a pyrrolyl or substituted pyrrolyl group having the general formula C₄NRₖ, where k≦4 and R is selected from the group consisting of hydrogen, alkyl, nitrile and aryl.

5. A composition as recited in claim 2, wherein said ligand comprises a pyrazolyl or substituted pyrazolyl group having the general formula C₃N₂Rₖ, where k≦3 and R is selected from the group consisting of hydrogen, alkyl, nitrile and aryl.

6. A composition as recited in claim 2, wherein said ligand comprises a pyridinyl or substituted pyridinyl group having the general formula of C₅NRₖ, where k≦4 and R is selected from the group consisting of hydrogen, alkyl, nitrile and aryl.

7. A composition as recited in claim 2, wherein said ligand comprises a pyridazinyl or substituted pyridazinyl group having the general formula C₄N₂Rₖ, where k≦3 and R is selected from the group consisting of hydrogen, alkyl, nitrile and aryl.

8. A composition as recited in claim 2, wherein said ligand comprises a pyrimidyl or substituted pyrimidyl group having the general formula of C₄N₂Rₖ, where k≦3 and R is selected from the group consisting of hydrogen, alkyl, nitrile and aryl.

9. A composition as recited in claim 2, wherein said ligand comprises a pyrazinyl or substituted pyrazinyl group having the general formula of C₄N₂Rₖ, where k≦3 and R is selected from the group consisting of hydrogen, alkyl, nitrile and aryl.

10. A composition as recited in claim 1, wherein said anion (Z) is selected from the group consisting of:
a) RSO₃⁻, where R is selected from the group consisting of alkyl, fluoroalkyl, perfluoroalkyl, aryl, fluoroaryl or perfluoroaryl;
b) N(SO₂RᵢR′ⱼ)⁻, where R is selected from the group consisting of alkyl, fluoroalkyl, perfluoroalkyl, aryl, fluoroaryl or perfluoroaryl, R′ is selected from alkyl, fluoroalkyl, perfluoroalkyl, aryl, fluoroaryl or perfluoroaryl, and i+j=2 and i=1 or 2;
c) C(SO₂RᵢR′ⱼ)⁻, where R is selected from alkyl, fluoroalkyl, perfluoroalkyl, aryl, fluoroaryl or perfluoroaryl, R′ is selected from hydrogen, alkyl, fluoroalkyl, perfluoroalkyl, aryl, fluoroaryl or perfluoroaryl, and i+j=3 and i=1, 2 or 3;
d) CB₁₁H₁₂₋ₘXₘ⁻, where m is from 0 to 12 and X is selected from the group consisting of halogen, alkyl, fluoroalkyl, perfluoroalkyl, aryl, fluoroaryl or perfluoroaryl;
e) CB₉H₁₀₋ₘXₘ⁻, where m is from 0 to 10 and X is selected from the group consisting of halogen, alkyl, fluoroalkyl, perfluoroalkyl, aryl, fluoroaryl or perfluoroaryl;
f) CB₁₁F₁₁R⁻, where R is selected from the group consisting of alkyl, fluoroalkyl, perfluoroalkyl, aryl, fluoroaryl or perfluoroaryl and ammonium;
g) B₁₂H₁₂₋ₘXₘ²⁻, where m is from 0 to 12 and X is selected from the group consisting of halogen, alkyl, fluoroalkyl, perfluoroalkyl, aryl, fluoroaryl or perfluoroaryl;
h) RCOO⁻, where R is selected from the group consisting of alkyl, fluoroalkyl, perfluoroalkyl, aryl, fluoroaryl or perfluoroaryl; and
i) common anions selected from the group consisting of Cl⁻, Br⁻, S0₄²⁻, HSO₄⁻, NO₃⁻, PO₄³⁻, HPO₄²⁻ and H₂PO₄₋.

11. A composition as recited in claim 1, wherein said composition is supported on a substrate.

12. A composition as recited in claim 11, wherein said substrate comprises a material selected from the group consisting of alumina, silica, zeolite, activated carbon and an aerogel.

13. An apparatus adapted to adsorb an adsorbate from a fluid mixture, wherein the apparatus comprises a composition as recited in claim 1.

14. A method for adsorbing an adsorbate from a mixture of gaseous components to form a purified gas stream, comprising the step of contacting the mixture of gaseous components with an adsorbing composition, the composition having the formula CuₓAₙL_{y}Z, where:
A is CO or an olefin and n=0 or n>0;
L is an electrically neutral ligand and 0<y<4; and
Z is an anion having charge x-
and wherein the mixture of gaseous components comprises at least about 0.01 vol. % H₂O and at least one of CO or an olefin.

15. A method as recited in claim 14, wherein said mixture of gaseous components further comprises at least about 1 vol. % H₂.

16. A method as recited in claim 15, wherein said mixture of gaseous components comprises at least about 3 vol. % H₂O.

17. A method as recited in claim 15, wherein said composition is supported on a substrate.

18. A method as recited in claim 16, further comprising the step of delivering said purified gas stream to a fuel cell.

19. A method as recited in claim 14, wherein L comprises one or more chemical groups selected from the list consisting of aryl or substituted aryl groups, pyrrolyl or substituted pyrrolyl groups, pyrazolyl or substituted pyrazolyl groups, pyridinyl or substituted pyridinyl groups, pyridazinyl or substituted pyridazinyl groups, pyrimidyl or substituted pyrimidyl groups and pyrazinyl or substituted pyrazinyl groups, or combinations thereof.
